(19) United States
(12) Patent Application Publication
(10) Pub. No.: US 2007/0158926 A1
(43) Pub. Date: Jul. 12, 2007

(54) Hydraulic azimuth drive for a wind power plant, featuring play compensation

(76) Inventor: Wolfgang Hahmann, Kempen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/582,502

(22) PCT Filed: Nov. 9, 2004
(86) PCT No.: PCT/EP04/12642

§ 371 Date: Feb. 22, 2007

(30) Foreign Application Priority Data
Dec. 9, 2003 (DE) 103 58 486.2

(51) Int. Cl. B62M 1/00

(52) U.S. Cl. 280/230

(57) ABSTRACT

The invention relates to a device for driving movable mechanical components (10; 12a, b), at least two (10; 12a, b) of which are effectively interconnected in such a way that one component (10) can be driven by means of the other component (12a, b), play being provided between said two components (10; 12a, b). Said play between the components (10; 12a, b) can be eliminated by moving or bracing at least said two components (10; 12a, b) towards or against each other with the aid of a hydraulic mechanism (14).

The invention relates to a device for driving movable mechanical components, of which at least two are dynamically connected to each other such that by means of one component the other component can be driven, play compensation existing between the indicated two components.

Generic devices as are available on the market in a plurality of embodiments are designed among others as rotary drives for purposes of rotary or swivelling adjustment of a tool with reference to a defined working direction. Often mechanical components or machine elements are used, in the manner of a crown gear and pinion for transmission of driving power for the indicated rotary or swivelling process, the pertinent gear wheel drives being especially well suited when larger transmission ratios are to be implemented. In this proven drive technology losses in energy and power transmission can be kept low and these drives have acquired great economic importance in cranes and excavators, and recently within so-called azimuth drives in wind power plants, parts of the azimuth drive being used to pivot the rotor head with its rotor blades, in order in this way to follow changing wind directions in order to be able to optimally use the wind force on the rotor blades by means of the wind power plant.

In the indicated gear wheel designs, backlash generally occurs between the teeth of the crown gears; this leads on the one hand to inaccuracies within the scope of incipient adjustment movements with the rotary or swivel drive, and on the other with frequent load changes due to the backlash very high stress occurs on the teeth of the gear wheel drive with the result that by “deflection” of the teeth the backlash increases even more and leads to breaking of individual teeth of the gear wheel drive. In this connection it must also be considered that these rotary or swivel drives are loaded not only by controlled motion sequences, i.e., by constant loads or accelerations and decelerations in the desired sequence of motions, but also by external dynamic loads. Especially in wind power plants gusty winds and changing loads on the rotor blades cause dramatically changing torque loads in the azimuth drives, and especially for high wind speeds and gusts peak values are reached which are a multiple of the steady-state load torques which is otherwise necessary for adjusting the rotor axis direction, and is designed for the respective drive device. In addition to the damage mentioned in the foregoing, it can moreover occur that bearing couplings, shafts, and other components in the drive train can be damaged; this leads to complete failure of the rotary or swivel drive because especially in the area of wind power plants the oscillating torques within the backlash prompt leading and subsequent fallback of the movable components within the drive train.

Fundamentally the backlash in the drive train cannot be avoided and is otherwise required as the necessary tooth profile backlash between the crown gear and pinion as well as in the gearing, but also as clutch play in the clutches of the rotary and swivel drive in order to thus be able to ensure functioning at all in operation.

Especially when several drives are acting in parallel on one crown gear in the known solution, there is the danger that individual drives will be overloaded by the pertinent separate contact. This is due to the design of the drive, since in this drive concept it is assumed that the total load for several drives is uniformly distributed among all of them. The backlash can however be cancelled as a randomly appearing quantity in one of these drives, in the other however at the same instant it can have assumed the maximum possible value. In the shock load which then takes place the drive which is connected without backlash at the instant will have to accommodate the total torque within its torsional stiffness before the load takes effect in the other. If all drives were engaged from the start without backlash, the load distribution would always be uniform is this respect.

For modern azimuth drives in current use, the attempt is made to eliminate the aforementioned backlash in the drive train by the mechanical brakes which are intended to stop the rotary or swivel drive not being completely opened during the adjustment process, but with a definable braking torque acting by grinding on one part of the movable components of the drive, the pertinent braking torque having to be so high that oscillating torque peaks cannot lead to cancellation of the absence of backlash. This in turn causes a distinctly overdimensioned driving power for the drive train and at the end the pertinent driving power is then dissipated in the brake; this leads to considerable wear of the brake and therefore to high operating costs.

On the basis of this prior art, the object of the invention is to further improve the known devices while maintaining the advantages for them, such that a solution is devised with which the backlash in the drive train can be eliminated without this leading to wear on the system parts, and the associated operating and maintenance costs. This object is achieved by a device with the features of claim 1 in its entirety.

In that, as specified in the characterizing part of claim 1, a hydraulic means moves or braces against each other at least the two components which are dynamically connected to each other such that the existing backlash between these components can be eliminated, the mechanical braking means in the prior art are replaced by a hydraulic pretensioning means which operates free of wear and thus does not cause increased maintenance and assembly costs. Since the hydraulic means acts accordingly on the dynamic connection between the movable mechanical components at their interface, at the site of the dynamic engagement the drive backlash is completely eliminated and with the backlash eliminated an additional driving force or driving torque can be applied via the hydraulic means, which then helps to drive the components which are in the backlash-free state with each other, preferably for obtaining a rotary or swivelling motion.

The solution as claimed in the invention need not be limited to the use of rotary or swivel drives, but can obviously also be used in the area of linear movements, where mechanical components with backlash which are otherwise present are dynamically connected to each other.

In one preferred embodiment of the device as claimed in the invention, one mechanical component is a driven wheel which is provided at least partially with a driving crown gear, the respective other component being a drive wheel which is provided at least partially with a driven crown gear. Preferably on opposing sides of the driven wheel there is one drive wheel each which in the opposite direction of rotation to each other with their parts on the driven crown gears are engaged with the parts of the drive crown gear of the driven wheel. In this way, regardless of the direction of rotation of the driven wheel, pretensioning between the movable components can be achieved via the hydraulic means, so that in each operating state of the device the indicated backlash is eliminated.

Preferably provision is furthermore made such that the hydraulic means has a first pump designed as a feed pump which with a definable feed pressure pretensions parts of a hydraulic circuit to which is connected at least one hydraulic motor which is dynamically connected to the mechanical component which can be assigned to it. Preferably for each drive wheel its own hydraulic motor is used. Preferably the hydraulic motors have the same motor displacement per revolution so that under the same pretensioning pressure they can produce an equally high torque. These torques however do not produce rotary motion for the driven wheel because the configuration is chosen such that the applied torques act in opposite directions on the assignable parts of the driving crown gear of the driven wheel and in this respect mutually cancel each other. In this way, the entire drive train is pretensioned in both directions of rotation and in this respect the backlash in the engaged teeth or in optionally used clutches is cancelled.

If in one preferred embodiment of the device as claimed in the invention, in addition to the first pump in the form of a feed pump, another second pump designed as a delivery or drive pump is connected to the hydraulic circuit which with an adjustable delivery flow of fluid is used to drive the mechanical components, it is possible with this additional second pump to superimpose the action of the first pump or feed pump such that it furthermore maintains the absence of backlash and in this way applies a drive torque to the driven wheel in order to drive it by swivelling or rotating accordingly.

In another especially preferred embodiment of the device as claimed in the invention, between the two hydraulic motors a switching valve is placed in the hydraulic circuit and can be connected to the tank by means of a connection point by way of a pressure limitation valve. Preferably provision is furthermore made so that the switching valve can be connected by means of another connection point to another pressure limitation valve with a set pressure which is higher than the set pressure of the first pressure limitation valve and that the two connecting points are located on opposite sides of the switching valve in the hydraulic circuit. With this configuration, in one operating position of the switching valve a type of flushing of the hydraulic-carrying parts of the device can be achieved, so that it need not be feared that otherwise the fluid-carrying components could clog with dirt or the like for longer idling operation of the device; this would possibly lead to failure of the entire device, and additionally by way of the two pressure limitation valves on opposite sides of the switching valve in this way the result can be that when extremely high load peaks occur, the two hydraulic motors are exposed to a definable maximum pressure in the same direction and thus can accommodate oscillating torques at twice the size up to a maximum pressure, which, when exceeded, always relieves the system in the direction of the tank, to the extent that the system pressure defined as maximum for operation of the hydraulic motors is never exceeded.

In another preferred embodiment of the device as claimed in the invention, provision may be made such that the hydraulic means can be supplied with a pressure medium of a definable pressure by means of an external pressure supply and/or with at least one internally connected hydraulic accumulator of the hydraulic circuit. Thus, on the one hand in emergency situations the pressure supply of the device can be externally guaranteed, and otherwise for the first pump or feed pump only small delivery volumes are necessary when for example during downtimes of the device it delivers pressurized medium into the respective hydraulic accumulator from which the energy stored in this way can be recovered at any time if the hydraulic circuit demands this additional power.

The device as claimed in the invention is detailed below with reference to the drawings. In this connection the figures in the form of circuit or hydraulic diagrams are schematic and are not drawn to scale.

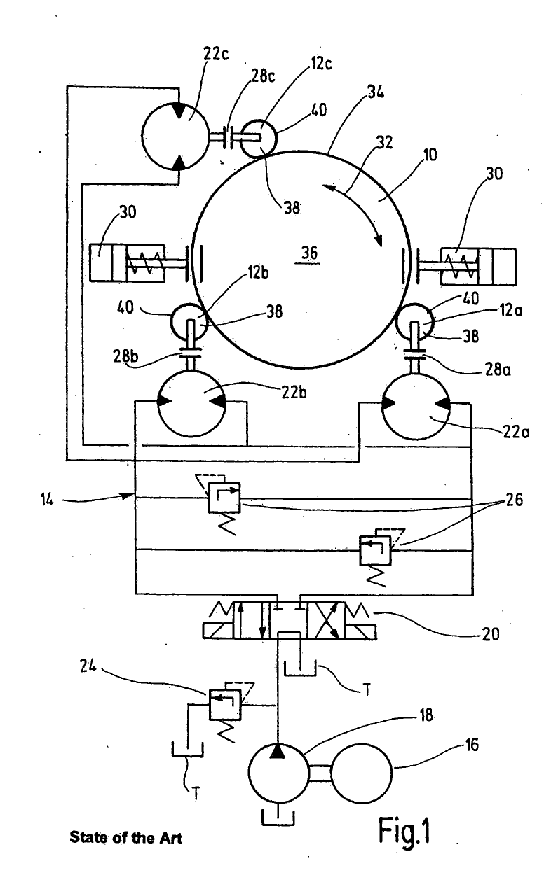

FIG. 1 shows a hydraulic device known in the prior art,

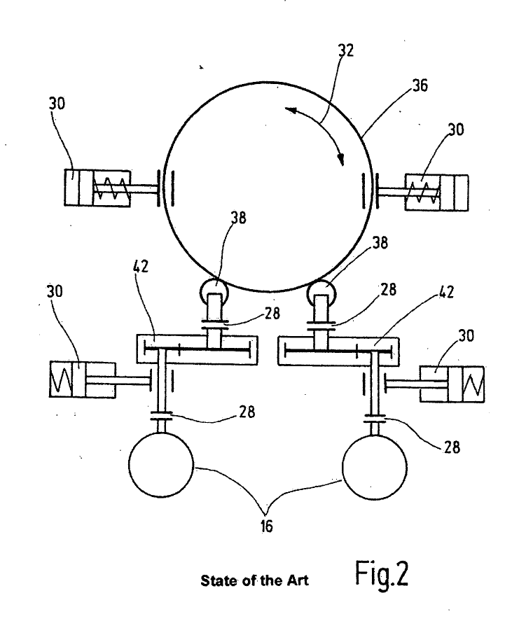

FIG. 2 shows an electromechanical means known in the prior art,

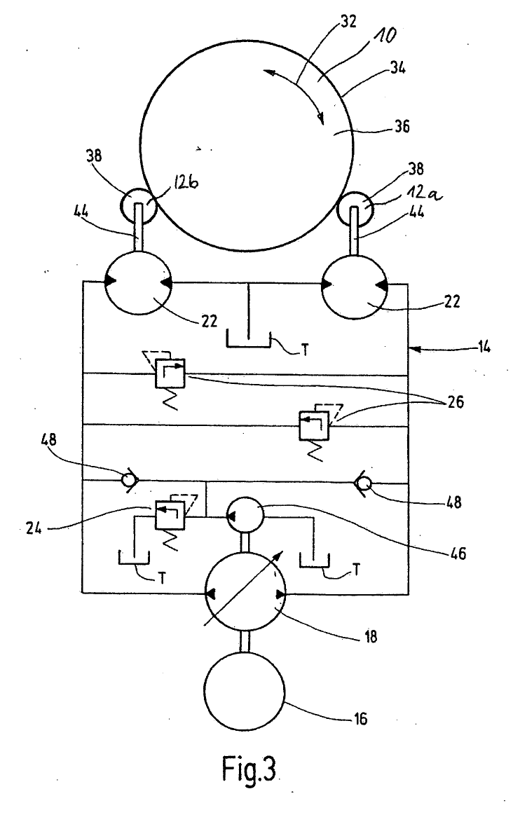

FIGS. 3 to 5 show different exemplary embodiments of the device as claimed in the invention,

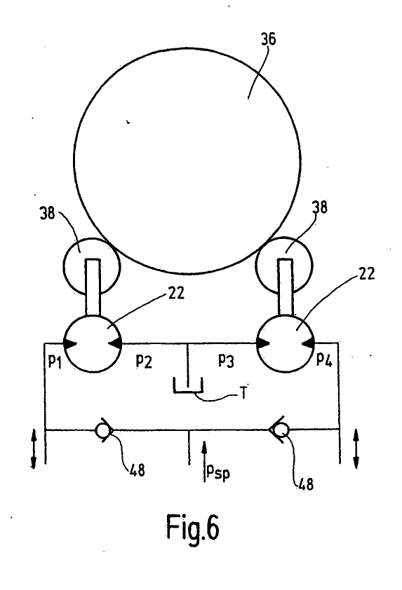

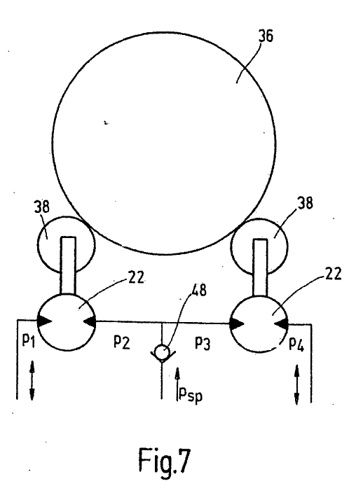

FIGS. 6 and 7 show schematics relative to one decentralized and one centralized feed,

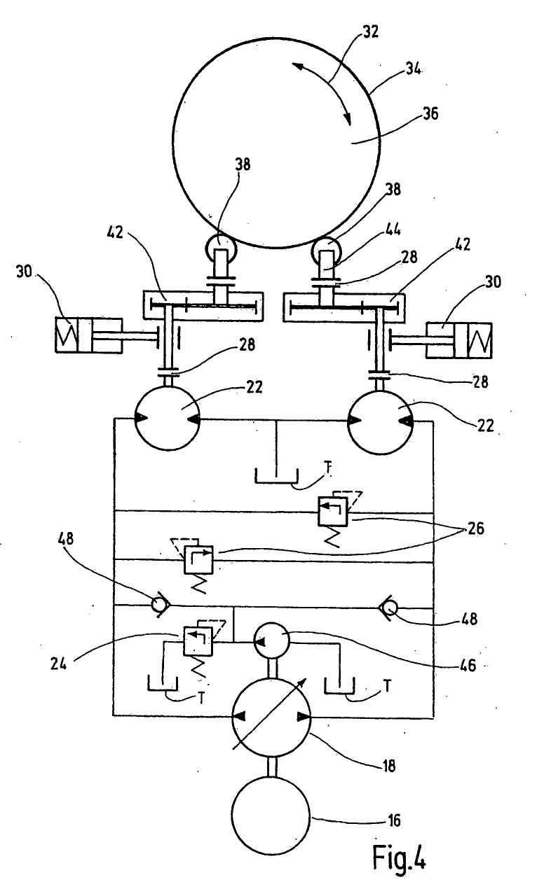

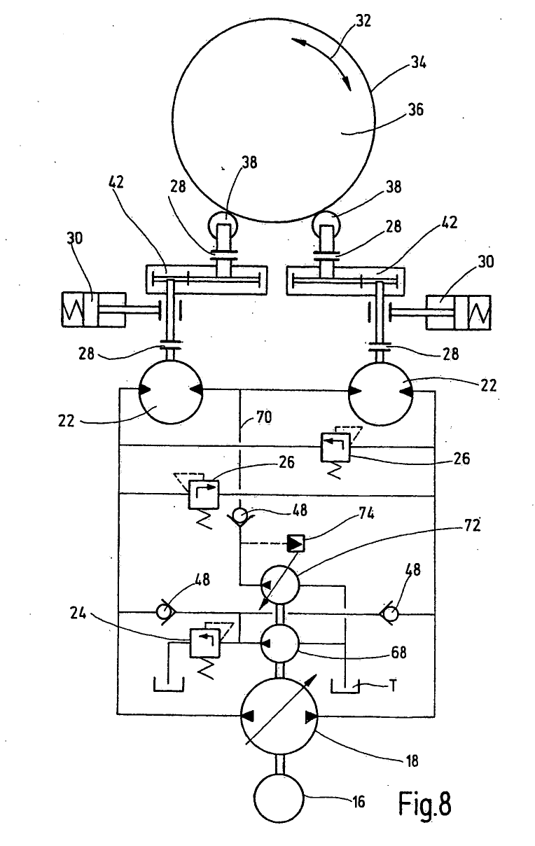

FIG. 8 shows another exemplary embodiment of the device as claimed in the invention with a structure comparable to the design as shown in FIG. 4, but with centralized high pressure feed.

FIG. 1 shows a known device for driving movable mechanical components 10; 12a, b, c, of which at least two 10; 12a, b, c are dynamically connected to each other such that by means of one component 12a, b, c the other component 10 can be driven, backlash existing between the indicated two components 10, 12a, b, c. The rotary or swivel drive shown in FIG. 1 is actuated by a hydraulic means designated as a whole as 14. The hydraulic pump 18 which can be driven by a drive motor 16 produces a fluid delivery flow, preferably with a hydraulic medium, which is routed by way of a rotary directional valve 20 as a 4/3-way valve to the respective hydraulic motor 22a, b, c, as soon as the rotary directional valve 20 is moved out of its middle position shown in FIG. 1, in one other operating position of the valve the hydraulic motors 22a, b, c turning in one direction and in the other operating position in the other direction. The indicated hydraulic motors are connected in this way within the hydraulic circuit of the hydraulic means 14 in a parallel configuration. The primary pressure limitation valve which is designated 24 in FIG. 1 protects the hydraulic pump 18 against overloading. For the middle position of the rotary directional valve 20 shown in FIG. 1, conversely the two secondary limitation valves 26 protect the hydraulic motors 22a, b, c against overloading and limit the load torques which act retroactively from the mechanical component 10 by way of the mechanical components 12a, b, c and assignable clutches 28a, b, c on the hydraulic motors 22a, b, c. Two braking means 30 which are located on either side of the mechanical component 10 can brake the motion of the mechanical component 10 in the possible directions of motion indicated by the double arrow 32, and when shut down also keep it stationary as required even in the approached position.

As shown in FIG. 1, one mechanical component 10 is a driven wheel 36 which is provided at least partially with a driving crown gear 34, the respective other components 12a, b, c being a drive wheel 38 which is provided on the outer peripheral side with a driven crown gear 40. Thus, on the opposing sides of the driven wheel 36 there is one drive wheel 38—a total of 3 items—which in the opposite direction of rotation to each other with their parts on the driven crown gears 40 are engaged to parts of the driving crown gear 34 of the driven wheel 36. For the sake of simpler representation, the individual teeth of the crown gears 34, 40 are omitted; however they are dynamically meshed with each other as is conventional in gear wheel drives. In the known solution shown in FIG. 1, the braking means 30 can remain continuously in dynamic contact with the driven wheel 36 and in this way can act by grinding on the driven wheel 36. Backlash which may be present is then avoided between the driven wheel 36 and the drive wheels 38, and for the actual drive motion the hydraulic pump 18 can overcome the pertinent braking moment, and by way of the hydraulic motors 22a, b, c and the respective drive wheels 38 can drive the driven wheel 36 along the rotary or swivelling directions, as shown by the double arrow 32.

If comparable components are used below, as have already been described for the solution as shown in FIG. 1 which can be demonstrated for the prior art, in this respect the same reference numbers are used for the same parts and components, and what was stated above then also applies to the embodiments as shown in the following figures. FIG. 2 relates in turn to a solution in the prior art, and likewise to a rotary or swivel drive, like the solution as shown in FIG. 1. In the known design as shown in FIG. 2 however an electromechanical power transmission solution is selected, two electric motors 16 replacing the hydraulic pump 18. To reduce the driven speed, between the respective electric motor 16 and the assignable drive wheel 38 an additional gear transmission 42 is connected which is made as a gear wheel drive. The pertinently mechanical gear transmission 42 often has an additional holding brake 30 with a holding torque which acts stepped-up on the wheels 36, 38 by the gear transmission 42; it is however used only as a holding brake, i.e., may be used only when the entire device is shut down. The gear transmission 42 in addition to the assignable holding brake 30 is used in a comparable manner also in hydraulic rotary drives (not shown).

The indicated rotary drives in the prior art are loaded not only by controlled motion sequences, that is to say by constant loads or accelerations and decelerations in the desired motion sequence, but also by dynamic external loads. In particular, in wind power plants gusty winds and changing loads on the rotor blades cause dramatically changing torque loads in the azimuth drives. These oscillating torques at high wind speeds can reach peak values which are a multiple of the steady-state load torques which are necessary for setting the rotor axle direction.

The existing backlash in the drive train for these oscillating torques leads to increased loads on the drive trains, to impacts in the teeth, bearings, clutches, shafts and other components located in the drive train, and thus to damage and to premature failure of the entire rotary drive, because the oscillating torques within the backlash promote leading and subsequent fallback of the indicated driving mechanism parts. Backlash in the drive train cannot be avoided and is present as the necessary tooth flank backlash between the crown gear and the pinion and in the gearing, but also as clutch play in the clutches. In current so-called azimuth drives as shown in FIGS. 1 and 2, the attempt is made to neutralize the backlash in the drive train by the respective brake 30 not being opened during the adjustment process, but “grinding” with the assignable braking torque. This braking torque must be sufficiently high so that oscillating torque peaks do not lead to nullification of the absence of backlash.

This in turn dictates considerably overdimensioned drive powers for the drives, whether in the form of a hydraulic pump 18 (FIG. 1), or in the form of electric drive motors 16 (FIG. 2). The overdimensioned drive power which is then to be routed through the respective drive train is then ultimately to be dissipated at its end in turn in the brake 30; this is accompanied by the indicated wear problems.

The solution as claimed in the invention is now characterized in that the absence of backlash of the drive is always ensured, that is to say, even at high oscillating torques, and this can take place without specific dissipation of excess energy.

FIG. 3 shows a first exemplary embodiment as a circuit diagram for such a drive, with all important components. An electric drive motor 16 in turn drives a hydraulic pump 18 as an adjustable pump which can deliver in both directions to a more or less closed hydraulic circuit. Thus, it then drives one hydraulic motor 22 at time which drives the driven wheel 36 by swivelling via a shaft 44 and the drive wheel 38 in the possible swivel directions as shown by the double arrow 32. The more or less closed hydraulic circuit is at this point pretensioned by a pump 46 in the manner of a feed pump. The pertinent pump 46 or feed pump can deliver into the hydraulic circuit by way of a feed line and check valves 48. The pressure with which the hydraulic circuit is pretensioned is in turn dictated by the setting of the feed pressure limitation valve 24. If the hydraulic pump 18 is in the zero position and does not deliver into either of the two lines of the hydraulic circuit, in the two assignable main lines or trains the pressure level dictated by the setting of the feed pressure limitation valve 24 prevails. Since the additional second port of the respective hydraulic motor 22 is connected to the tank T, the hydraulic circuit is termed more or less closed, as defined above. Since the tank connection T is almost unpressurized (ambient pressure), the pressure difference on the hydraulic motors 22 produces a torque which is routed by the hydraulic motors 22 via the drive train 44, 38 to the driving crown gear 34 of the driven wheel 36.

The two hydraulic motors 22 have the same motor displacement per revolution, so that under the same pretensioning pressure they produce an identically high torque. These torques however do not produce rotary motion of the driven wheel 36 because the hydraulic motors 22 are installed such that their torques act against each other on the driven crown gear 40 and consequently on the drive wheel 36, that is to say, cancel each other due to the opposing position. But in any case they pretension the drive train of both sides such that a completely backlash-free connection between the components of the indicated drive trains results. Here it is irrelevant whether the backlash in the teeth and/or in the corresponding clutches can be “displaced”; this will be detailed below in the exemplary embodiments as shown in FIG. 4.

If in this state an external torque acts on the gondola of a wind power plant, for example due to wind forces, depending on the direction of action for the hydraulic motor 22 which is already producing an oppositely acting torque under pretensioning, it produces an increase of this torque. In this connection the hydraulic motor 22 is supported on the oil side in the hydraulic circuit toward the hydraulic pump 18, and toward the respective check valve 48 in the feed line. In this connection the pressure in the line rises according to the external torque. Only if this pressure were to exceed the value dictated by the secondary pressure limitation valves 26 (maximum pressure limitation valves) would the respectively assignable secondary pressure limitation valve 26 open, and noticeable movement for the driven wheel 36 would occur. The second hydraulic motor 22 with torque acting in the same direction as the external torque does not undergo a change of load since the first or feed pump 46 maintains the pretensioning pressure. Thus, the backlash-free connection is maintained to its full extent on this otherwise unloaded side of the drive train.

To adjust the indicated gondola which acts on the driven wheel 36, depending on the desired rotary or swivel direction the hydraulic pump 19 is actuated accordingly. The load torques opposite the direction of rotation at this point cause a rise in the pressure in the line to the assignable hydraulic motors 22 into which the pump 18 feeds, while on the intake side of the pump 18 the pressure is determined by the feed pressure limitation valve 24. In this state the hydraulic motor 22 which produces a constant torque against the direction of motion also delivers into this intake line. It now acts as a pump which acquires its drive power from the crown gear 34 of the driven wheel 36. The hydraulic pump 18, aside from the inevitable volumetric and hydraulic-mechanical losses of such a drive need apply only the power which is necessary due to the load torques occurring during the driving motion.

At this point the drive should be designed such that load torque peaks in or opposite the direction of rotation do not lead or only quite briefly lead to response of the second pressure limitation vales 26. This ensures that uncontrolled movements cannot occur. Continuous feed by way of the feed pump 46 ensures that the backlash is completely removed from the drive trains.

In the exemplary embodiment as shown in FIG. 4, a comparable structure is implemented as in the exemplary embodiment as shown in FIG. 3 on the condition that an intermediate gear transmission 42 is connected between the hydraulic motors 22 and the drive wheels 38 and has clutches 28 in both directions. Furthermore, there is a braking means 30 which acts on the pertinent drive train in order to shut down the respective drive train when the device has been shut down. Otherwise this mode of operation of the exemplary embodiment as shown in FIG. 4 is described accordingly as above for the exemplary embodiment as shown in FIG. 3.

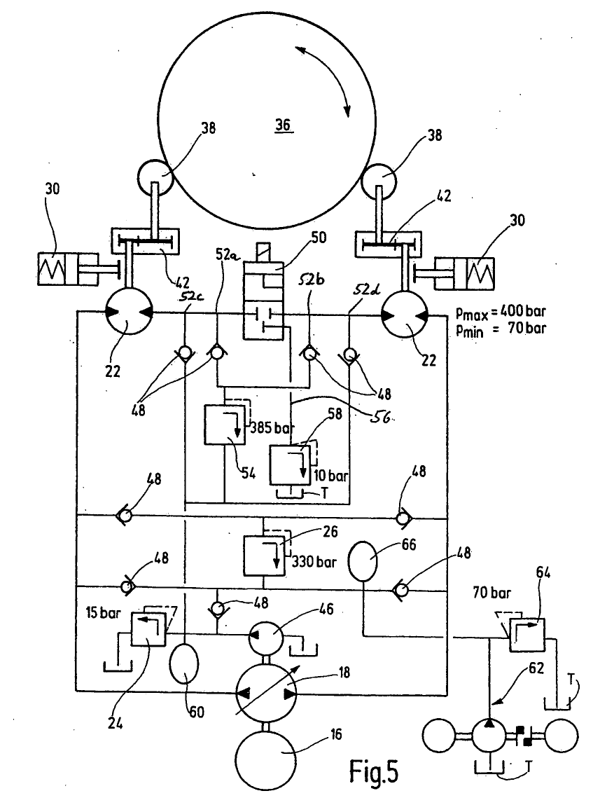

The exemplary embodiment as shown in FIG. 5 is comparably designed especially with respect to the drive trains, like the exemplary embodiment as shown in FIG. 4. The new exemplary embodiment in this respect compared to the previous exemplary embodiments is supplemented in that between the two hydraulic motors 22 a 3/2 switching valve 50 is placed in the hydraulic circuit. At the connection points 52a and 52b the pressure limitation valve 54 is connected via check valves 48, its outlet connection leads likewise by way of check valves 48 to the ports 52c and 52d. Furthermore, the outlet connection is connected to the low pressure circuit of the feed pump 46, with a pressure dictated by the pressure limitation valve 24. Moreover the switching valve 50 on its opposing side can be connected by means of another connecting line 56 to a further pressure limitation valve 58 with a set pressure which is lower than the set pressure of the pressure limitation valve 24. If the switching valve 50 is not actuated, and remains in its blocked position as shown in FIG. 5, it is possible with these pressure limitation valves 54, 26 to protect the hydraulic motors against overloading, for example to the indicated maximum pressure of 400 bar. The pressure values given in FIG. 5 in bar are only examples, and can accordingly also assume other values in a modification.

When the valve 50 is actuated, the two hydraulic motors 22 are connected to each other so as to carry fluid, and are also connected to the tank T by way of the pressure limitation valve 58. In this way the system can be flushed with fluid in order in this way to discharge dirt onto the tank side T. The feed pump 46 can moreover deliver the pressurized medium internally to a hydraulic accumulator 60 so that in this respect it becomes possible for the accumulator to be able to supply the hydraulic motors 22 accordingly with pressurized fluid in a larger amount. Furthermore, this solution has an external pressure supply, designated as a whole as 62, for producing the pretensioning which is protected by way of a pressure limitation valve 64, and otherwise can guarantee pressure supply by way of the other internal hydraulic accumulator 66. In this way emergency supply for the pretensioning function can be achieved if the main drive train 16, 18, 46 should fail. With the exemplary embodiments as shown in FIGS. 4 and 6 a low-loss rotary or swivel drive without backlash can be implemented.

In the aforementioned solutions, so-called decentralized feed which is shown in FIG. 6 in terms of its basic principle is implemented. The usable torque of the hydraulic motors 22 is proportional to the prevailing pressure difference p₄−p₁. Furthermore, for decentralized feed the lower of the two pressures is equal to the feed pressure. If therefore due to high load torques high pretensioning is required in order to remain free of backlash, the usable torque is reduced accordingly by the amount of feed pressure. The physical relationships are the following here:

Resulting useful torque
M_{N}−((p₄−p₁)+(p₂−p₁)*V/2/π
with p₂−p₃≈0 and p₁, p₄<pₘₐₓ
M_{N}=(p₄−p₁)*V/2/π
Pretensioning torque
Mₛₚ=pₛₚ*V/2/π
Maximum useful torque
M_{Nmax}=(pₘₐₓ−pₛₚ)*V/2/π

Under comparable system assumptions centralized feed as shown in FIG. 7 does not have the above described limitation, specifically that for operation which is free of backlash the usable torque is reduced accordingly by the amount of the feed pressure. In centralized feed, in contrast to decentralized feed, the feed pressure is supplied centrally between the two hydraulic motors 22, as shown in FIG. 7. In this version the average pressure can be selected to be very high without limiting the useful torque, so that the central feed system can reasonably also be called a high pressure feed system. Feed of high pressure centrally between the two hydraulic motors 22 causes an identical torque which pointed oppositely likewise pretensions the drive train, so that it has no backlash. Especially applications with load torque peaks which far exceed the required useful torque for producing the adjustment movement due to external loads can be reliably managed by a drive train which remains free of backlash.

The system conditions for centralized feed are as follows:

Resulting useful torque
M_{N}−((p₄−p₃)+(p₂−p₁))*V/2/π
with p₂=p₃≈pₛₚ and p₁, p₂, p₃, p₄<pₘₐₓ and p₁, p₄<pₛₚ
M_{N}=(p₄−p₁)*V/2/π
Pretensioning torque
Mₛₚ=pₛₚ*V/2/π
Maximum useful torque
M_{Nmax}=pₘₐₓ* V/2/

So that an adverse negative pressure does not form in the main lines between the hydraulic pump 18 and the two hydraulic motors 22, the main lines can be connected to the tank T via replenishing valves (not shown). Instead of replenishing valves, a low pressure feed pump 68 according to the exemplary embodiment as shown in FIG. 8 can also be used which relates to a backlash-free, low-loss hydraulic rotary drive with centralized high pressure feed and decentralized low pressure feed and in this respect constitutes a continued embodiment of the solution as shown in FIG. 4, with only decentralized pressure feed.

The drive as shown in FIG. 8, similarly to the exemplary embodiment shown in FIG. 4, has additional gear transmissions 42 in the drive train which are connected via clutches 28 to the respective hydraulic motor 22 and to the assigned pinion (drive wheel 38). Moreover, in turn each drive train is equipped with a brake 30 which is made as a holding brake. With this embodiment the holding brake function can also be performed with the drive turned off. After braking by the drive (operating brake function) the holding brake 30 can be engaged with the drive trains pretensioned. In this way the gondola (driven wheel 36) becomes free of backlash and is kept pretensioned in position.

A pressure-controlled high pressure feed pump 72 delivers fluid coming from the tank under high pressure into the high pressure feed line 70 which with its one end discharges into a connecting line between the two hydraulic motors 22, the backflow from the two hydraulic motor 22 to the feed pump 72 being blocked by way of a check valve 48. This high pressure feed pressure control means 74 shown in FIG. 8 can be used instead of a feed pressure limitation valve; this entails the advantage that only as much feed oil flow is used as is necessary.

Since the level of the oscillating torques which are acting on the rotary drive for the azimuth movement of a wind power plant can be subjected to very strong fluctuations, which has been repeatedly determined and which can be predicted in time to a limited degree, it is expedient, in conjunction with the expected weather conditions, to adapt the level of the pretensioning in the drive train to the oscillating torques which are to be expected. This has the advantage that in times of very small oscillating torques only low pretensioning is used, and when for example hurricane gusts are expected, very high pretensioning is used. In this way both the tooth flanks and also other parts loaded proportionally to the pretensioning are loaded only as strongly as necessary and also the occurrence of backlash even under extremely high loads is prevented.

1. Device for driving movable mechanical components (10; 12a, b, c), of which at least two (10; 12a, b, c) are dynamically connected to each other such that by means of one component (12a, b, c) the other component (10) can be driven, backlash existing between the indicated two components (10; 12a, b, c), characterized in that at least these two components (10; 12a, b, c) are moved or braced against each other by a hydraulic means (14) such that the existing play compensation between these components (10; 12a, b, c) can be eliminated.

2. The device as claimed in claim 1, wherein one mechanical component (10) is a driven wheel (36) which is provided at least partially with a driving crown gear (34) and wherein the respective other component (12a, b, c) is a drive wheel (38) which is provided at least partially with a driven crown gear (40).

3. The device as claimed in claim 2, wherein on opposing sides of the driven wheel (36) there is one drive wheel (38) each which in the opposite direction of rotation to each other with their parts on the driven crown gears (40) are engaged with the parts of the drive crown gear (34) of the driven wheel (36).

4. The device as claimed in claim 1, wherein the hydraulic means (14) has a first pump (46) which with a definable feed pressure pretensions parts of a hydraulic circuit to which at least one hydraulic motor (22a, b, c) is connected which is dynamically connected to the mechanical component (12a, b, c) which can be assigned to it.

5. The device as claimed in claim 4, wherein in addition to the first pump (46) another second pump (18) is connected to the hydraulic circuit which with an adjustable delivery flow is used to drive the mechanical components (10; 12a, b, c).

6. The device as claimed in claim 4, wherein the hydraulic motor (22) directly drives the driven wheel (36) or via an intermediate gear transmission (42).

7. The device as claimed in claim 5, wherein the two pumps (18, 46) can be driven by a common drive motor (16).

8. The device as claimed in claim 6, wherein between the two hydraulic motors (22) a switching valve (50) is placed in the hydraulic circuit and wherein a pressure limitation valve (54) can be connected by means of connecting points (52a, b).

9. The device as claimed in claim 8, wherein the switching valve (50) can be connected by means of another connecting line (56) to another pressure limitation valve (58) with a set pressure which is lower than the set pressure of the first pressure limitation valve (24).

10. The device as claimed in claim 1, wherein the hydraulic means can be supplied with a pressure medium of a definable pressure by means of an external pressure supply (62) and/or with at least one internally connected hydraulic accumulator (60) of the hydraulic circuit.

11. The device as claimed in claim 1, wherein the pretensioning pressure can be applied in a centralized or decentralized manner.
